(19) United States
(12) Patent Application Publication
(10) Pub. No.: US 2021/0030048 A1
(43) Pub. Date: Feb. 4, 2021

(54) Food grade feeder device and system for placing rolls, egg, meat, or protein patties, and/or cheese and other foodstuffs to assemble and prepare a sandwich

(71) Applicant: Greg Schombert, Knightstown, IN (US)

(72) Inventor: Greg Schombert, Knightstown, IN (US)

(21) Appl. No.: 16/944,681

(22) Filed: Jul. 31, 2020

Related U.S. Application Data
(60) Provisional application No. 62/882,460, filed on Aug. 2, 2019.

(51) Int. Cl. A23P 20/20; B65G 19/02; B65G 19/22; B65G 47/14; B65G 21/20; B65G 47/53

(52) U.S. Cl. CPC A23P 20/20; B65G 19/02; B65G 19/225; B65G 47/14; B65G 23/24; B65G 47/53; B65G 2201/0205; B65G 2201/0202; B65G 2207/26; B65G 21/2072

(57) ABSTRACT

An automated food grade conveyor, placement and feeder device and system for singulating and placing rolls, egg, meat, or protein patties, and/or cheese and other foodstuffs to assemble and prepare a sandwich, the system being made of food grade materials that are easily cleanable and being made compact and on wheels which results in a system that significantly reduces time, labor, and waste while increasing productivity, quality and freshness; it includes bulk feeding specific food items through a food grade centrifugal feed system, placing the food items with a chain driven pick and place device, transferring food items to separate servo driven trains, automatically placing of a food pattie onto a sliced bun, wrapping of a completed sandwich, and placing the sandwich on a tray, box or container.

### CROSS-REFERENCE TO RELATED APPLICATIONS

This application claims the benefit of United States Provisional patent application with Ser. No. 62/882,460 filed on Aug. 2, 2019, by Greg Schombert and entitled “A food grade feeder device and system for placing rolls, egg, meat, or protein patties, and/or cheese and other foodstuffs to assemble and prepare a sandwich called a Patty Placer”.

### FIELD OF INVENTION

This invention relates to a food grade feeder device and system. Particularly it relates to a food grade conveyor, placement and feeder device and system for placing rolls, egg, meat, or protein patties, and/or cheese and other foodstuffs to assemble and prepare a sandwich called a Patty Placer. The present disclosure relates generally to the preparation of food products and, more particularly, but not by way of limitation, to preparing sandwiches. It also relates to a sandwich preparation apparatus or food handling system that incorporates a system that automates the process. The present invention relates to a clean product aligning device made of food grade materials that are easily cleanable and able to be washed in hot water and steam. This invention relates to an apparatus for the assembling of a biscuit or roll sandwich with the addition of egg, meat or protein patties, cheese and other condiments and foodstuffs. More particularly, it relates to an apparatus for the faster, more compact assembling of roll or biscuit sandwiches ready for packaging by using a singulating system that significantly reduces time, labor, and waste while increasing productivity, quality and freshness. Although unconfirmed, the system may also be used to aid in packaging, for instance, food, medical, pharmaceutical and military special handling products.

### FEDERALLY SPONSORED RESEARCH

None.

### SEQUENCE LISTING OR PROGRAM

None.

### BACKGROUND—FIELD OF INVENTION AND PRIOR ART

As far as known, there are no food grade feeder device and system for a food grade feeder device and system for placing rolls, egg, meat, or protein patties, and/or cheese and other foodstuffs to assemble and prepare a sandwich. It is believed that this product is unique in its design and technologies.

### BACKGROUND

This background as to food machinery for fast processing should be useful. A significant portion of the cost of manufacturing certain food products results from the labor cost in handling such products during manufacturing and/or packaging. Conventional hamburgers have a meat patty in a bun along with various condiments and sauces. A variety of other types of hamburgers and sandwiches have recently become popular and are in high demand at food outlets. These include, for example, such items as the teriyaki burger (adding teriyaki sauce to a conventional hamburger), bacon and lettuce burgers, cheeseburgers with different types of cheeses, barbecue sauce burgers, fish sandwiches, chicken sandwiches, and roast beef sandwiches. New types and kinds of products are being introduced regularly. The words “hamburger” and “sandwich” are interchangeably used in this specification unless otherwise specified. One sees that a demand for increased productivity has arisen because of an increase in the number of consumers and increasingly diversified tastes.

Most of the food preparation has been manually performed. Each section for the preparation is independent of the others. Conventional kitchen productivity has been examined, analyzed, and improved many times, and it is difficult to make more improvements. An automated hamburger fixing apparatus has been developed to increase efficiency and reduce the required manual labor. Some of the apparatuses use a feeding and adding mechanism for each different element, condiment or sauce. The application of this type of an apparatus is very limited due to the large/long footprint and amount of space required for the feeding and adding of multiple mechanisms. Changes are unwieldy due to the need to add another feeding and adding mechanism every time a new sauce or condiment is added to the menu. In addition, the control system of the machine must be modified every time a change for feeding another condiment is made. Further, it is impossible to install such a long and complex apparatus in a small conventional kitchen or even a larger food preparation area.

In some other industries, various parts or products are placed into packets or pouches for health, sterile, convenience or protective reasons. These are then placed in large quantity boxes or other containers for ultimate delivery to the consumer or customer. Currently, placement of the food or other packets into the boxes or other shipping containers is done by hand, which is labor intensive and time consuming. Centrifugal precision feeders can be developed to aid in this process, but they must be manufactured from a food grade material. The materials or food stuff can be then placed on the flexible, cleanable inner disc and are transferred from the inner disc to sorting mechanism and eventually fed to a next station. The use of a food grade centrifugal feeder system can remove the skewed orientation which traditionally has prevented rapid packaging of the material or the packages before they are placed in the shipping containers.

Necessarily, equipment is needed for the efficient packaging of the food product. Quite often the equipment must be individually designed and built for the intended food product to be packaged. The equipment must be capable of receiving food in bulk, separating or segregating it to desired serving sizes and packaging it. The equipment must be capable of handling large amounts of the raw food product in a very fast manner to work efficiently and competitively with manual packaging operations. One food product which is becoming more popular in package form are sandwiches. Hamburger and sausage sandwiches are quite common; however, they typically are not assembled by the food processor and packaged as a complete product ready for consumption. One reason for this is the lack of equipment to efficiently handle bread, buns or biscuits and combine them with a pre-cooked meat patty or fillet in sandwich form.

### Problem Solved

What is desired therefore is an apparatus with a compact footprint, the apparatus being capable of automating at least part of the sandwich-making process in a consistent, reliable manner. Desired is a method and system for making sandwiches using a singulating system that significantly reduces time, labor, and waste while increasing productivity, quality and freshness.

The improvement and problem solved is a fast and efficient manner for food processing of sandwiches accomplished by the food grade feeder device and system for rolls, sandwiches, odd shaped edibles and foodstuff. The system is a fast, precise, clean and compact way to align and position food products such as rolls, mead, produce and garnishments in way to reduce time and labor as well as fit into smaller locations and foot prints as compared to other conveyor and manual sandwich-making systems. The invention overcomes a long-sought need of the food preparation industry that feeds millions at fast food restaurants, convenient marts, coffee houses and other “food on the go” companies.

### PRIOR ART

A novelty search was completed for the food grade feeder device and system for rolls, sandwiches, odd shaped edibles and foodstuff. It revealed the following:
A. U.S. Pat. No. 9,532,575 by Donis, et al. issued in 2017 is for an automated sandwich assembly unit. This is an automatic sandwich maker designed to automate the process of preparing sandwiches, including hamburgers, is included. This automated sandwich maker is designed for use in commercial kitchens, including small commercial kitchens, such as fast-food kitchens. The apparatus and method for automatically making sandwiches overcomes the drawbacks and limitations of the prior art. The individual sandwich process can be controlled by communications interface with a point of sales system. The inventive apparatus and method reduce manpower requirements for restaurants, provides enhanced ingredient control, and improves overall product quality.
B. U.S. Pat. No. 7,383,937 by Perreault, et al. issued in 2008 is for an Article feeder and spacer. Shown is a feeder for orienting and aligning disorderly incoming items includes a rotatable table having a peripheral wall and a discharge opening in the peripheral wall, the discharge opening allowing the items in a predetermined orientation to be successively withdrawn from the rotatable table in a single file line, the rotatable table being fed with disorderly items; a first carrier disposed proximate to the discharge opening, the first carrier recovering the oriented items exiting through the discharge opening; and an item spacer mounted proximate to the first carrier, the item spacer providing a predetermined spacing between two consecutive oriented items. It also relates to a method for doing same.
C. U.S. Pat. No. 7,228,953 by Perreault, et al. issued in 2007 is for an Article feeder and spacer. This device is a feeder for orienting and aligning disorderly incoming articles includes a table having a peripheral wall, a rotary surface surrounded by the peripheral wall, and a discharge substantially tangential to the peripheral wall, the discharge being sized to receive one article at a time from the rotary surface in a predetermined orientation; and at least one pile eliminating member extending above the rotary surface and defining a gap with the rotary surface, the gap being sized to solely permit passage of non-superposed articles laying in the predetermined orientation on the rotary surface. It also relates to a method for doing same and a method and an apparatus for removing obstructing blocks from the discharge.
D. U.S. Pat. No. 6,237,741 by Guidetti issued in 2001 is for a Process for controlling the operation of machines for processing articles, for example for packaging food products, and the machine thereof. Provided is a process for controlling the operation of machines for processing articles includes the step of synchronously controlling the movement or speed of a feeding device and an intake branch of the machine. The process provides a method of adapting a processing machine to adjust to discontinuities in an otherwise continuous flow of articles being supplied to the machine for processing. The process provides for the speed of the feeding device and the speed of the intake branch to both be reduced simultaneously. The speed of the feeding device is slowed sufficiently that it obtains a minimum speed at the time that the perceived discontinuity reaches the interface of the feeding device and the intake branch. Simultaneously, the speed of the intake branch is reduced to a substantially standstill condition at the time that the feeding device obtains its minimum speed. The process may further provide for the standstill condition of the intake branch to be maintained until the first article, positioned after the detected discontinuity, reaches the intake branch. The process may then provide for the reactivation of the intake branch to bring the feeding device and the intake branch back to their normal operating conditions.
E. U.S. Pat. No. 5,634,551 by Francioni, et al. issued in 1997 is for a Method and apparatus for regulating the advancing movement of articles, for example in installations for the automatic packaging of food products. Shown here is a device for regulating the advancing movement of articles in a given direction comprises a plurality of conveyors, such as for example belt conveyors, between an input supply conveyor and a positive drive output conveyor operating to supply, for example, a packaging machine. In order to adapt automatically to the handling of articles with different lengths, at least some of the aforesaid conveyors, intended to perform a phasing action of the advancing movement of the articles, are chosen with different lengths so as to form a set which is able to deal with the possible range of variation in the length of the articles dealt with, by coupling several conveyors in cascade. Preferably, the conveyor at the downstream end has a selectively controllable length varied in dependence on the length of the articles being handled.
F. U.S. Pat. No. 5,540,943 by Naramura issued in 1996 is for a Sandwich preparation apparatus. This is a sandwich preparation apparatus includes a food material conveyor having an upstream end region and a downstream finishing end region. The bottom part of a sandwich or burger, including a bun half or slice of bread, has sauces and condiments, and a patty if necessary, automatically added by a first automatic fixing section in the upstream end region. The upper part of the sandwich, optionally including additional sauces, condiments, and patties, is completed by a second automatic fixing section in the downstream finishing end region. Between the two regions is a manual fixing section for an operator to manually add various food materials to the sandwich. The operator controls the automatic fixing sections through first and second input devices and an order display device. The operator can change the order or sequence of sandwiches between the upstream end region and the downstream end region using the second input device. The operator is thus able to make allowances for different cooking or preparation times for different types of sandwiches.
G. U.S. Pat. No. 5,299,675 by Schumann, et al. issued in 1994 is for a Pouch feeder method and device with angled rim. Demonstrated is a precision feeding device for soft and hard packaged articles includes an angled rim for improved feeding and alignment. Separated rollers are placed between a rigid plate and a flexible disc to further enhance the operation and durability of the device.
H. U.S. Pat. No. 5,101,716 by Cones, Sr. et al. issued in 1992 is for an Apparatus for assembling biscuit sandwiches. Notate here is an apparatus for the assembly of biscuit and meat sandwiches comprises a feeder station for receiving whole biscuits, a slicer station for slicing the biscuits in half, a separator station for separating the two halves of the biscuit and sending them along separate pathways, and an assembly station having a hold station where precooked meat patties are held and where the biscuit halves and the meat patties are assembled into a sandwich ready for packaging. A series of conveyors transport the food components between the stations.
I. U.S. Pat. No. 5,044,487 by Spatafora, et al. issued in 1991 is for a Product aligning device, particularly for supplying wrapping machines. This demonstrates a device for aligning products, wherein an annular body turning about its axis presents an annular end surface defining a first route for the product items arranged in line, and an inner lateral surface defining, with the upper surface of a flat disc turning about its axis and on to which the product is fed in bulk, a second annular route for the product; the annular body being inclined in relation to the disc; so as to define a first junction between the first and second route, and a second junction between the first route and a third route defined by an output conveyor tangent to the annular body; the disc being fed in bulk with the product items, which are fed, by centrifugal force, on to the second route and then, one by one, on to the first route via the first junction and on to the third route via the second junction.
J. U.S. Pat. No. 4,530,632 by Sela issued in 1985 is for a Stacking apparatus for flexible, generally planar food products. This is an apparatus for counting and stacking food products such as tortillas. The tortillas are initially placed on an entry chute containing many air outlets for creating a cushion of air to allow the tortilla to slide down the entry chute onto an incline conveyor belt. The conveyor belt is of an open mesh design and it is supported on a belt support having many air inlets which create a vacuum that maintains the tortilla in contact with the belt. The tortillas are carried by the belt down one end of the belt support and along the underside of the belt support with contact between the tortilla and belt being maintained by vacuum creating air inlets formed in the belt support. The air inlets terminate at a location on the underside of the belt support thereby allowing the tortillas to drop from the conveyor belt. The tortillas drop onto a stationary rack formed by rods which are interleaved with conveyor belts moving together as a unit. The conveyor belts are normally positioned beneath the upper surface of the rack. However, when a predetermined number of tortillas have been stacked, the belt is lifted thereby carrying the tortillas from the rack. The mechanism for lifting the belts is actuated by a counter which counts a predetermined number of tortillas passing past a counting station and delays actuating the belt lifting mechanism until the final tortilla has dropped onto the rack. The belts discharging the stacks of tortillas move in the direction opposite the direction that the tortillas are delivered to the rack in order to minimize the time required to remove the tortillas from the rack before an additional tortilla may be placed thereon. And,
K. U.S. Pat. No. 3,224,554 by J. E. Mouldert et. al. issued in 1965 is for an Automatic Orientation, Alignment and input feeding machinery for confectionary articles. Here is an invention that relates to automatic systems for handling
large masses of confectionary articles and in particular
to automatic input feeding machinery for lining up and feeding confectionary articles in predetermined orientation into apparatus for further operations to be performed upon them.

As can be observed, none of the prior art has anticipated or caused one skilled in the food processing and preparation art to see this invention as obvious to one skilled in the industry. The food grade feeder device and singulating system for placing rolls, egg, meat or protein patties, and/or cheese and other foodstuffs to assemble and prepare a sandwich called a Patty Placer provides an answer to a clean, compact and fast manner to organized, align and singularly foodstuffs such as rolls, buns, meats and other food in a compact and efficient manner.

### SUMMARY OF THE INVENTION

This invention is a method and system for making sandwiches using a singulating system that significantly reduces time, labor, and waste while increasing productivity, quality and freshness. This the preferred embodiment of this system is comprised of: (a) bulk feeding specific food items (egg, meat or protein patties, possibly cheese and/or other food items) through a food grade centrifugal feed system; (b) placing or sliding the food items with a chain driven pick and place or slide and place device; thus (c) transferring over food items to two separate servo driven trains; (d) placing of pattie into/onto sliced bun by automatic and/or manual means; (e) wrapping of completed sandwich if desired; and, (h) placing on serving or transfer tray, box or container. Indeed, this combination of devices in specific process steps has been found advantageous in providing the desired apparatus and/or method for making sandwiches. The preferred embodiment of the system for the food grade feeder device anticipates: A food grade feeder device and system comprised of: (a) an egg, meat or protein centrifugal feeder; (b) an optional roll, biscuit, or bun centrifugal feeder; (c) a biscuit conveyor and a roll and pattie gathering conveyor with a transfer rail to deflect roll and patties from biscuit conveyor to gathering conveyor and with multiple guide rails; (d) a pair of servo drive chains to turn patties or other foodstuffs/items, the pair of servo drive chains further comprising a pair of motors and gear drives, a chain, and a set of pockets on drive chain; (e) a slider rail between servo drive; (f) a placement device of the pattie into a sliced bun; and (g) an optional pack out tray, box, or gathering device wherein the food grade system for placing egg, meat and/or protein patties onto rolls/biscuits and assembling a sandwich and an optional person attending sandwich assembly are able to efficiently and quickly assembly sandwiches in a relatively small workplace and floor space.

### Objects and Advantages

There are several objects and advantages of the food grade feeder device and system called a Patty Placer. These various advantages and benefits include:

| Item | Advantages |
|---|---|
| 1 | greatly reduces labor to manufacture a sandwich |
| 2 | increases output rate and productivity |
| 3 | reduces time to assemble sandwich |
| 4 | reduces cost to manufacture sandwiches |
| 5 | is washable, easy to clean and resistant to steam |
| 6 | provides a compact footprint for less use of floor |
| | space and uses less floor space than manual labor |
| 7 | reduces contaminants |
| 8 | reduces waste |
| 9 | can singulate and place an egg and/or sausage |
| | patty with no changeover between products, |
| | therefore the time to assemble sandwich and less |
| | changeover time allows components and foodstuff to |
| | be fresher |
| 10 | is easy to use and maintain |
| 11 | can be used for any ready to eat sandwich - |
| | breakfast, lunch and dinner |

Finally, other advantages and additional features of the present food grade feeder device and singulating system to assemble and prepare a sandwich called a Patty Placer will be more apparent from the accompanying drawings and from the full description of the device. For one skilled in the art of fast food preparation and food preparation, it is readily understood that the features shown in the examples with this product are readily adapted to other types of compact and fast food processing equipment and tools.

### DESCRIPTION OF THE DRAWINGS—FIGURES

The accompanying drawings, which are incorporated in and constitute a part of this specification, illustrate an embodiment of the food grade feeder device and system to assemble and prepare a sandwich. The drawings together with the summary description given above and a detailed description given below explain the principles of the A Food grade feeder device and system called a Patty Placer. It is understood, however, that the feeding device and system is not limited to only the precise arrangements and instrumentalities shown.

FIGS. 1 A through 1 C are sketches of the general Food grade system for egg, meat and protein patties onto rolls and assembling a sandwich for sandwich making applications.

FIG. 2 is a sketch of the general Food grade system for egg, meat and protein patties onto rolls and assembling a sandwich device and accessories with components and features noted.

FIGS. 3 A through 3 E are sketches of the egg, meat and protein patty centrifugal feeder, the servo drive train, and transfer conveyors with device components and features shown from generally a top view.

FIGS. 4 A through 4 D are sketches of the patties transfer by the servo drive train onto the transfer conveyors.

FIG. 5 is a sketch of the servo drive chain at the patty to roll transfer point and gathering conveyors.

FIGS. 6 A through 6 C are sketches of full patties to roll system from the centrifugal feeder, through the servo drive chains and where the patties and rolls/buns are first placed together.

FIGS. 7 A through 7 D are sketches of prior art for food and sandwich transfer assembly.

### DESCRIPTION OF THE DRAWINGS—REFERENCE NUMERALS

The following list refers to the drawings:

TABLE B
Reference numbers

| Ref # | Description |
|---|---|
| 30 | Food grade system 30 for singulating and placing |
| | egg, meat, and protein patties 70 onto sliced |
| | rolls/biscuits 72 and assembling a sandwich 74 |
| 40 | Egg, meat or protein centrifugal feeder 40 |
| 45 | Roll or bun 72 centrifugal feeder 45 |
| 50 | Bun/roll/biscuit 72 transfer conveyor 50 |
| 52 | Transfer rail 55 to deflect a sliced roll and |
| | patties combination 70, 72 from biscuit conveyor |
| | 50 to gathering conveyor 55 |
| 54 | Support wheels 54 |
| 55 | Roll 72 and patties 70 transfer/gathering |
| | conveyor 55 |
| 57 | Guide rail 57 |
| 60A, | Servo drive chains 60A, B to turn patties 70 or |
| B | other foodstuffs/items |
| 62 | Motor and gear drive 62 |
| 63 | Chain 63 of servo chains 60A, 60B |
| 64 | Pockets 64 on drive chain 63 |
| 65 | Slider rail 65 between servo drive 60A, 60B |
| 66 | placement device 66 of pattie 70 into sliced |
| | roll 72 |
| 70 | Egg, meat or protein patties 70 |
| 72 | Sliced roll/bun or biscuit 72 |
| 74 | Pattie 70 and top and bottom bun 72 sandwich 74 |
| 85 | Pack out tray, box, or gathering device 85 |
| 90 | Optional person 90 attending sandwich assembly |
| 91 | person 91 finishing sandwich assembly |
| 100 | Prior art 100 U.S. Pat. No. 5,299,675 |
| 101 | Prior art 101 U.S. Pat. No. 5,540,943 |
| 102 | Prior art 102 U.S. Pat. No. 9,532,575 |
| 103 | Prior art 103 U.S. Pat. No. 5,101,716 |

### DETAILED DESCRIPTION OF PREFERRED EMBODIMENT

This invention relates to a food grade feeder device and singulating system. Particularly it relates to a food grade conveyor, placement and feeder device and system for placing rolls, egg, meat, or protein patties, and/or cheese and other foodstuffs to assemble and prepare a sandwich called a Patty Placer. The present disclosure relates generally to the preparation of food products and, more particularly, but not by way of limitation, to preparing sandwiches. It also relates to a sandwich preparation apparatus or food handling system that incorporates a system that automates the process. The present invention relates to a clean product aligning device made of food grade materials that are easily cleanable and able to be washed in hot water and steam. This invention relates to an apparatus for the assembling of a biscuit or roll sandwich with the addition of egg, meat or protein patties, cheese and other condiments and foodstuffs. More particularly, it relates to an apparatus for the faster, more compact assembling of roll or biscuit sandwiches ready for packaging by using a singulating system that significantly reduces time, labor, and waste while increasing productivity, quality and freshness. Although unconfirmed, the system may also be used to aid in packaging, for instance, food, medical, pharmaceutical and military special handling products.

The advantages for the food grade feeder device and system to assemble and prepare a sandwich called a Patty Placer 30 for placing rolls, egg, meat and protein patties, and/or cheese and other foodstuffs. Succinctly the benefits are that the device and system:
A. greatly reduces labor to manufacture a sandwich;
B. increases output rate and productivity;
C. reduces time to assemble sandwich;
D. reduces cost to manufacture sandwiches;
E. is washable, easy to clean and resistant to steam;
F. provides a compact footprint for less use of floor space and uses less floor space than manual labor;
G. reduces contaminants;
H. reduces waste;
I. can singulate and place an egg and/or sausage patty with no changeover between products, therefore the time to assemble sandwich and less changeover time allows components and foodstuff to be fresher;
J. is easy to use and maintain; and
K. can be used for any ready to eat sandwich—breakfast, lunch and dinner.

This invention is a method and system for making sandwiches using a singulating system that significantly reduces time, labor, and waste while increasing productivity, quality and freshness. This the preferred embodiment of the process for the system is comprised of: (a) bulk feeding specific food items (egg, meat or protein patties, eggs, possibly cheese and/or sliced tomatoes and other food items) through a food grade centrifugal feed system; (b) placing or sliding the food items with a chain driven pick and place or slide and place device; thus (c) transferring over food items to two separate servo driven trains; (d) placing pattie into sliced bun items by automatic and/or manual means; (e) wrapping of completed sandwich, if desired, and (f) placing on serving or transfer tray, box or container. The preferred embodiment of the system for the food grade feeder device anticipates: A food grade feeder device and system 30 comprised of: (a) an egg, meat or protein centrifugal feeder 40; (b) an optional roll, biscuit, or bun centrifugal feeder 45; (c) a biscuit conveyor 50 and a roll 72 and pattie 70 gathering conveyor 55 with a transfer rail 55 to deflect roll 72 and patties 70 from biscuit conveyor 50 to gathering conveyor 55 and with multiple guide rails 57; (d) a pair of servo drive chains 60A,60B to turn patties 70 or other foodstuffs/items, the pair of servo drive chains 60A,60B further comprising a pair of motors and gear drives 62, a chain 63, and a set of pockets 64 on drive chain 63; (e) a slider rail 65 between servo drive 60A,60B; (f) a placement device 66 of the pattie into a sliced bun; and (g) a pack out tray, box, or gathering device 85 wherein the food grade system 30 for placing an egg, meat and/or protein patties 70 onto rolls/biscuits 72 and assembling a sandwich 74 and a person 90 attending and finishing the sandwich assembly is able to efficiently and quickly assembly sandwiches in a relatively small workplace and floor space.

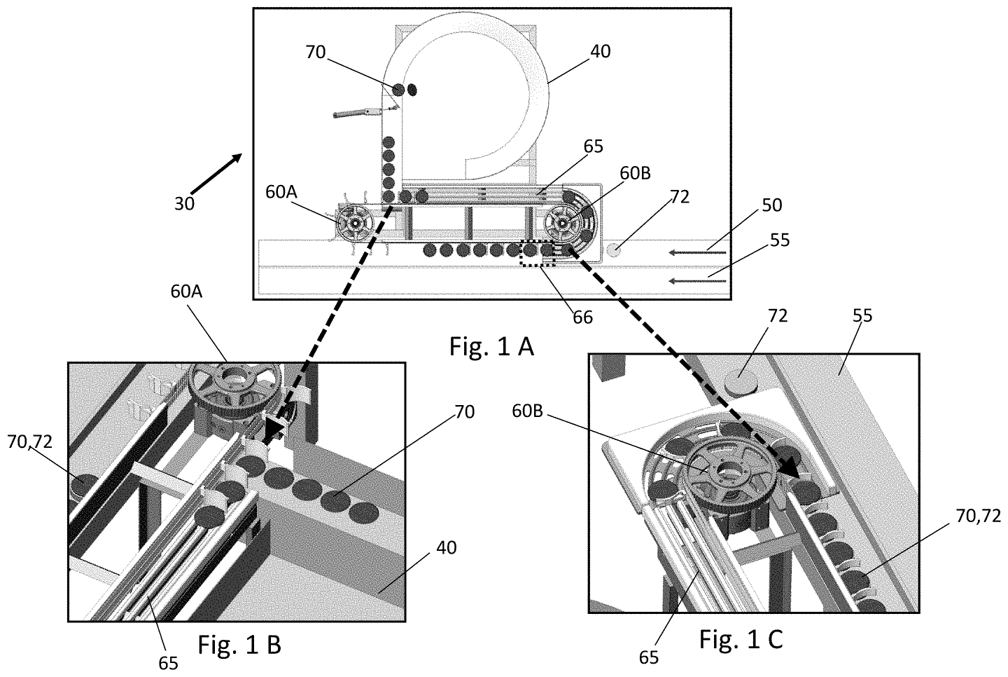

There is shown in FIGS. 1-7 a complete description and operative embodiment of the food grade feeder device and system 30 to assemble and prepare a sandwich called a Patty Placer. In the drawings and illustrations, one notes well that the FIGS. 1-7 demonstrate the general configuration and use of this product. The various example uses are in the operation and use section, below.

The accompanying drawings, which are incorporated in and constitute a part of this specification, illustrate an embodiment of the food grade feeder device and system food grade feeder device and singulating system 30 for placing rolls, egg, meat, or protein patties, and/or cheese and other foodstuffs to assemble and prepare a sandwich called a Patty Placer that is preferred. The drawings together with the summary description given above and a detailed description given below explain the principles of the food grade feeder device and singulating system 30. It is understood, however, that the device 30 is not limited to only the precise arrangements and instrumentalities shown. Other examples of food placing and assembling machines and systems for preparing sandwiches and their uses are still understood by one skilled in the art of food feeding equipment and devices to be within the scope and spirit shown here.

FIGS. 1 A through 1 C are sketches of the general food grade system 30 for egg, meat, or protein patties onto rolls and assembling a sandwich for sandwich making applications. Shown generally in these views of the food grade system 30 are: a food grade system 30 for singulating and placing egg, meat, and protein patties 70 onto sliced rolls/biscuits 72 and assembling a sandwich 74; an egg, meat or protein centrifugal feeder 40; a biscuit conveyor 50; a roll 72 and patties 70 transfer/gathering conveyor 55; a pair of servo drive chains 60A,60B to turn patties 70 or other foodstuffs/items; a slider rail 65 between servo drive 60A,60B; an egg, meat or protein patties 70; a roll/bun or biscuit 72; and an egg, meat or protein pattie 70 and top and bottom bun 72.

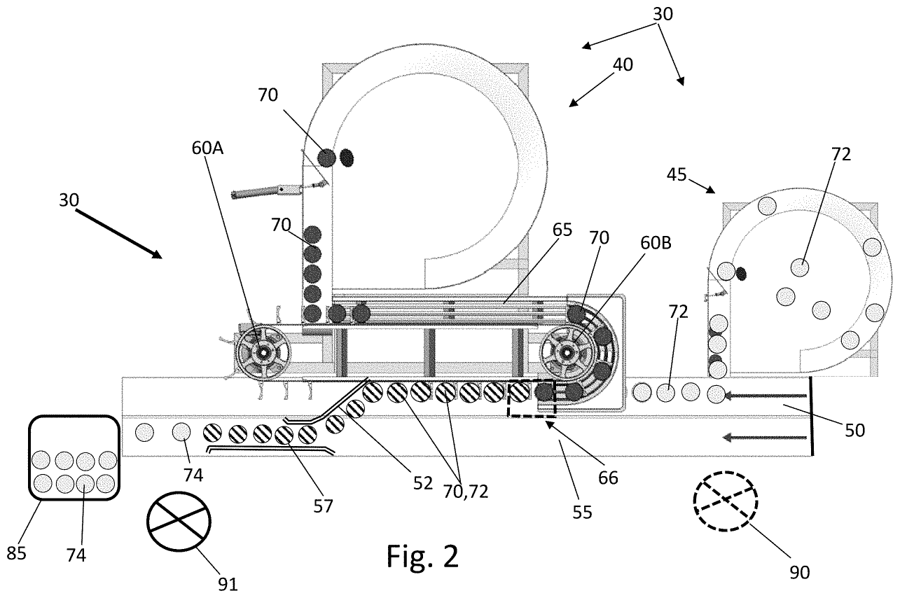

FIG. 2 is a sketch of the general food grade system 30 for an egg, meat, or protein patties onto rolls and assembling a sandwich device and accessories with components and features noted. Demonstrated in this generally top view of the singulating food system 30 is: a food grade system 30 for placing egg, meat and protein patties 70 onto rolls/biscuits 72 and assembling a sandwich 74; an egg, meat or protein centrifugal feeder 40; a roll, biscuit, or bun centrifugal feeder 45; a biscuit conveyor 50; a transfer rail 52 to deflect a roll and patties combination 70, 72 from biscuit conveyor 50 to gathering conveyor 55; a roll 72 and patties 70 transfer/gathering conveyor 55; a guide rail 57; servo drive chains 60A, 60B to turn patties 70 or other foodstuffs/items; a set of pockets 64 on drive chain 63; a slider rail 65 between servo drive 60A,60B; an egg, meat, or protein patties 70; a roll/bun or biscuit 72; an egg, meat or protein pattie and top and bottom bun 70,72; a sandwich 74; a condiment pumping device 75; a pressure line 76 for condiments; a sandwich pick and place 77; a pick and place 80 for sandwich 74; a pack out tray, box, or gathering device 85; and an optional person 90 attending sandwich assembly.

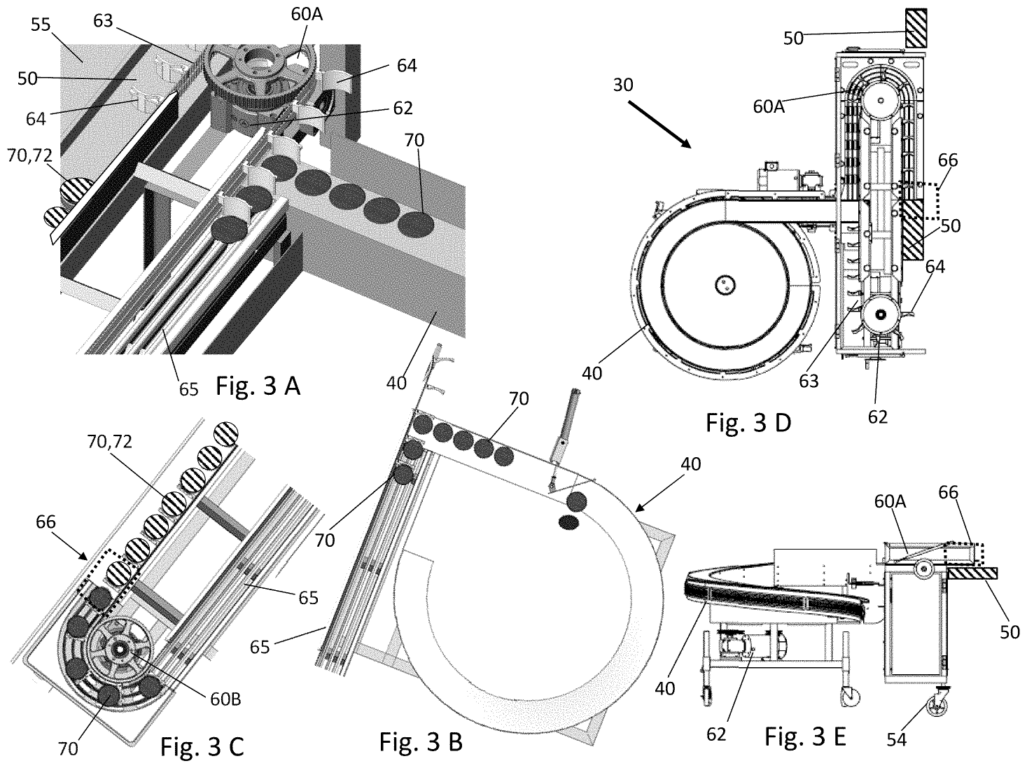

FIGS. 3 A through 3 E are sketches of the egg, meat, or protein patty centrifugal feeder, the servo drive train, and transfer conveyors with device components and features shown from generally a top view. Components and devices portrayed by these views consist of: a food grade system 30 for singulating and placing egg, meat, and protein patties 70 onto sliced rolls/biscuits 72 and assembling a sandwich 74; an egg, meat or protein centrifugal feeder 40; a biscuit conveyor 50; a set of support wheels 54; a sliced roll 72 and patties 70 transfer/gathering conveyor 55; servo drive chains 60A,60B to turn patties 70 or other foodstuffs/items; a motor and gear drive 62; a chain 63 of servo chains 60A,60B; a set of pockets 64 on drive chain 63; a slider rail 65 between servo drive 60A,60B; an egg, meat, or protein patties 70; a roll/bun or biscuit 72; and an egg, meat or protein pattie 70 and top and bottom bun 72.

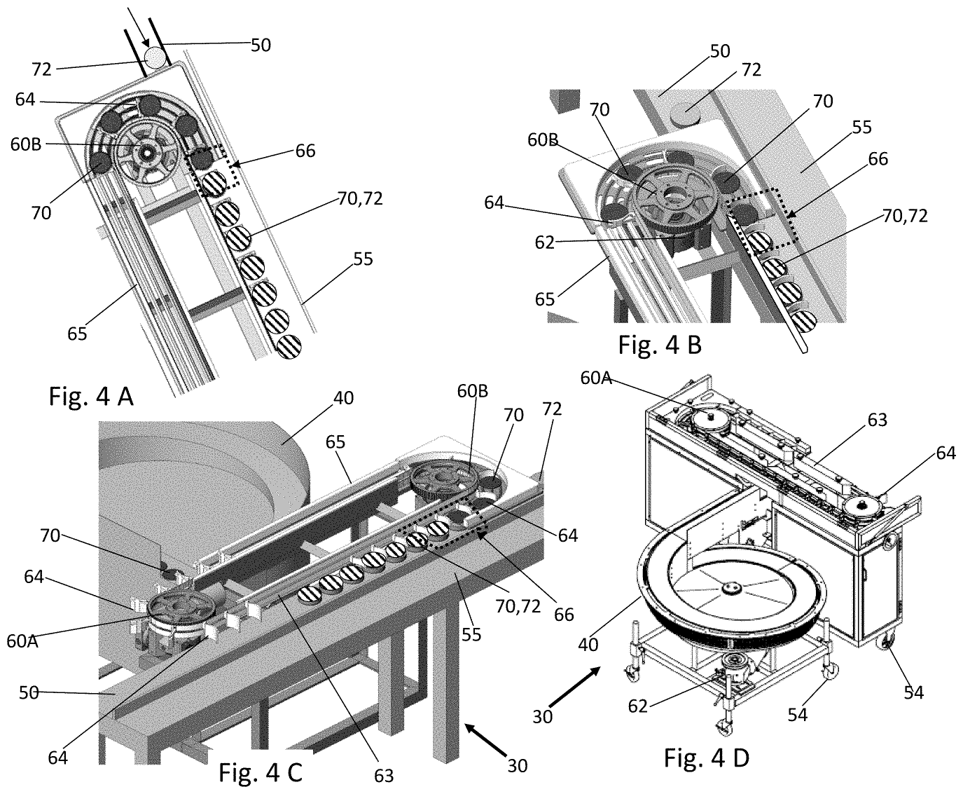

FIGS. 4 A through 4 D are sketches of the patties 70 transfer by the servo drive train 60A,60B onto the biscuit and transfer conveyors 50, 55. These views show: a food grade system 30 for placing egg, meat, and protein patties 70 onto sliced rolls/biscuits 72 and assembling a sandwich 74; an egg, meat or protein centrifugal feeder 40; a biscuit conveyor 50; a set of support wheels 54; a roll 72 and patties 70 transfer/gathering conveyor 55; servo drive chains 60A,60B to turn patties 70 or other foodstuffs/items; a motor and gear drive 62; a chain 63 of servo chains 60A,60B; a set of pockets 64 on drive chain 63; a slider rail 65 between servo drive 60A,60B; an egg, meat, or protein patties 70; a sliced roll/bun or biscuit 72; and an egg, meat, or protein pattie and/or bottom bun 72.

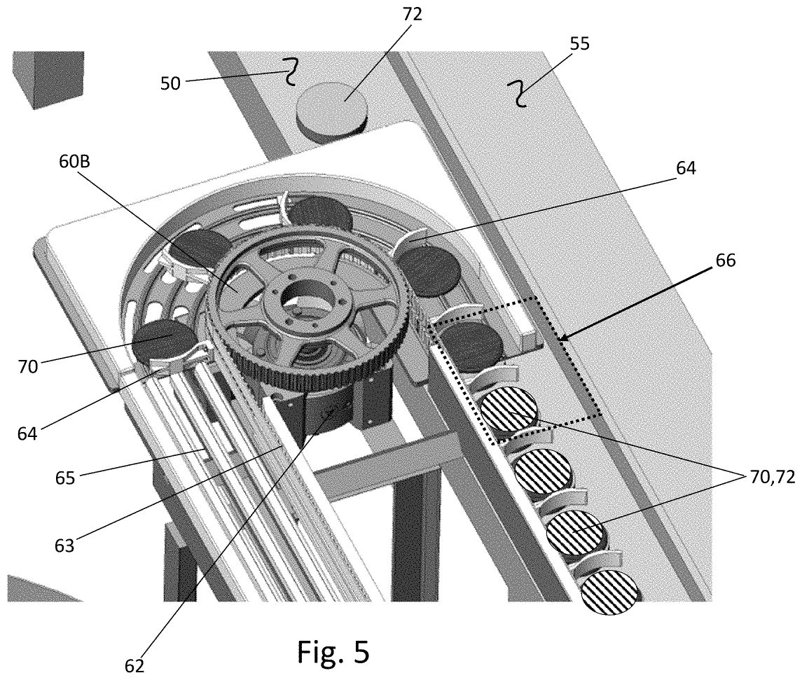

FIG. 5 is a sketch of the servo drive chain 60A,60B at the patty 70 to roll/biscuit 72 transfer point and gathering conveyors 50, 55. Here the drawings provide: a bun/roll/biscuit centrifugal feeder 45; a biscuit conveyor 50; a roll 72 and patties 70 transfer/gathering conveyor 55; a drive chain 60B to turn patties 70 or other foodstuffs/items; a motor and gear drive 62; a chain 63 of servo chain 60B; a set of pockets 64 on drive chain 63; a slider rail 65 between servo drive 60A,60B; an egg, meat, or protein patties 70; a roll/bun or biscuit 72; and an egg, meat or protein pattie and a bottom bun 70,72.

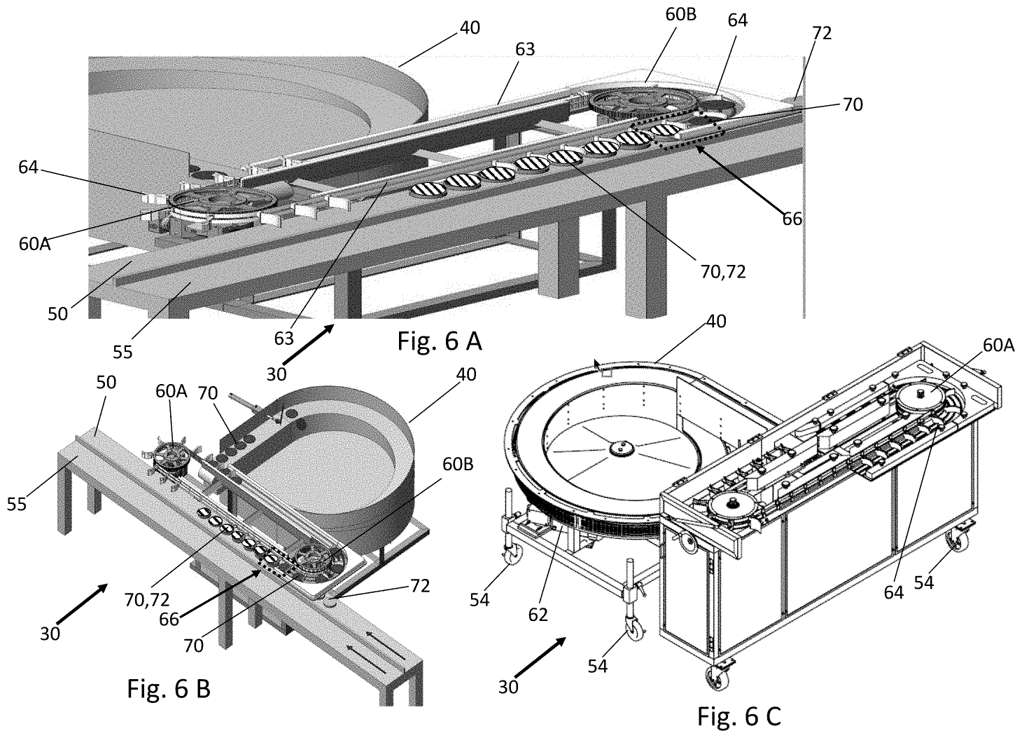

FIGS. 6 A through 6 C are sketches of full patties 70 to roll 72 singulating system 30 from the centrifugal feeder 40, through the servo drive chains 60A,60B and where the patties 70 and rolls/buns 72 are first placed together. In these views, one sees: a food grade system 30 for placing egg, meat, and protein patties 70 onto sliced rolls/biscuits 72 and assembling a sandwich 74; an egg, meat or protein centrifugal feeder 40; a biscuit conveyor 50; a set of support wheels 54; a roll 72 and patties 70 transfer/gathering conveyor 55; servo drive chains 60A,60B to turn patties 70 or other foodstuffs/items; a chain 63 of servo chains 60A,60B; a set of pockets 64 on drive chain 63; a slider rail 65 between servo drive 60A,60B; an egg, meat or protein patties 70; a roll/bun or biscuit 72; and an egg, meat, or protein pattie and a bottom bun 70,72.

The anticipated durable materials for the food grade feeder device and system 30 for placing rolls, egg, meat or protein patties, and/or cheese and other foodstuffs to assemble and prepare a sandwich called a Patty Placer include: for the part contact surfaces—an Acrylonitrile-Butadiene-Styrene (ABS) Plastic Disc, a 304 Stainless Steel Tooling ring, a FDA approved Acetal Resin belt material or equal for each conveyor, a 304 Stainless Steel Reorientation Cam, a 304 Stainless Steel Height Qualifier, Frame Construction—a 304 Stainless Steel Tubing with wash down casters and docking station. All are washable with hot water and commercial/industrial soaps for food preparation and all can resist extreme hot water and steam sprays for quasi sterilization. Sizes and construction details anticipated are wash down motor/gearbox w/common part numbers; all bearings to be sealed and greasable with Zerk fittings and pointing outwardly for access; and, a drive pulley to be of a griptwist material or equal. As durable and high temperature composite materials are developed, it is anticipated they can replace some of the Stainless-Steel components.

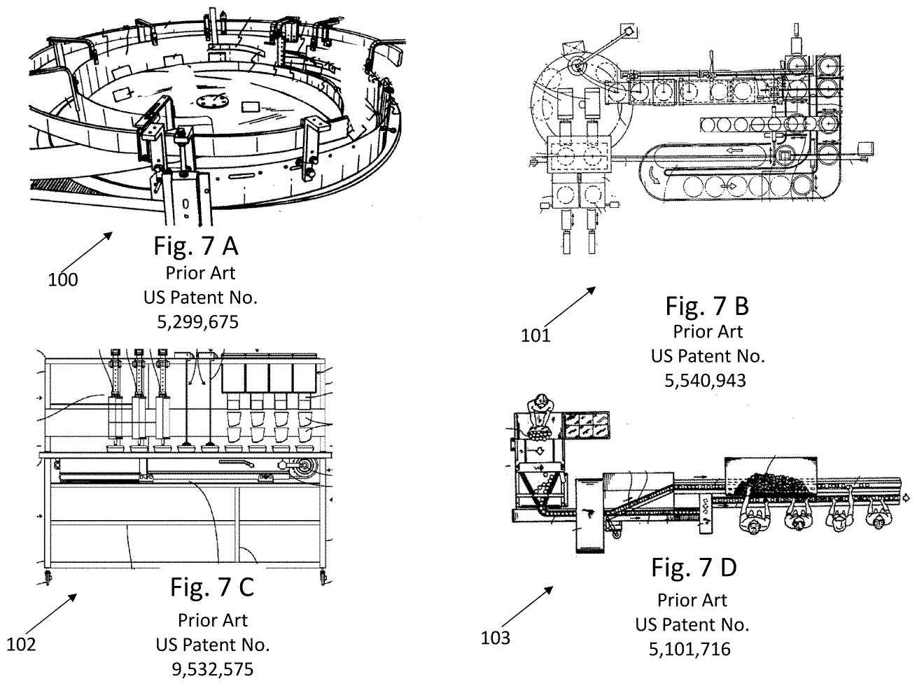

FIGS. 7 A through 7 D are sketches of prior art for food and sandwich transfer assembly. Here former patents and applications for food feeding machinery devices and systems are shown. These include: prior art 100 U.S. Pat. No. 5,299,675 by Schumann, et al. issued in 1994 is for a Pouch feeder method and device with angled rim; prior art 101 U.S. Pat. No. 5,540,943 by Naramura issued in 1996 is for a Sandwich preparation apparatus; prior art 102 U.S. Pat. No. 5,101,716 by Cones, Sr. et al. issued in 1992 is for an Apparatus for assembling biscuit sandwiches; and prior art 103 U.S. Pat. No. 9,532,575 by Donis, et al. issued in 2017 is for an Automated sandwich assembly unit. As can be seen, the novel food grade feeder device and system 30 for rolls, sandwiches, odd shaped edibles and foodstuff as compared to prior art is a unique combination and use as described herein.

The details mentioned here are exemplary and not limiting. Other specific components and manners specific to describing a food grade feeder device and system 30 to assemble and prepare a sandwiches can be added as a person having ordinary skill in the field of the art of food feeding equipment and their uses well appreciates.

### Operation of the Preferred Embodiment

The food grade feeder device and system 30 food to assemble and prepare a sandwich Placer by placing rolls, egg, meat, or protein patties, and/or cheese and other foodstuffs and called a Patty has been described in the above embodiment. The manner of how the device operates is described below. One notes well that the description above and the operation described here must be taken together to fully illustrate the concept of the new food assembly device and singulating system 30.

The preferred embodiment of a process for the food grade feeder device is a method and system for making sandwiches using a singulating system that significantly reduces time, labor, and waste while increasing productivity, quality and freshness. This process is comprised of: (a) bulk feeding specific food items (egg, meat or protein patties, eggs, possibly cheese and/or sliced tomatoes and other food items) through a food grade centrifugal feed system; (b) placing or sliding the food items with a chain driven pick and place or slide and place device; thus (c) transferring over food items to two separate servo driven trains; (d) placing pattie into sliced bun by automatic and/or manual means; (e) wrapping of completed sandwich if desired and (f) placing on serving or transfer tray, box or container.

The preferred embodiment of the system for the food grade feeder device anticipates: A food grade feeder device and singulating system 30 comprised of: (a) an egg, meat or protein centrifugal feeder 40; (b) an optional roll, biscuit, or bun centrifugal feeder 45; (c) a biscuit conveyor 50 and a roll 72 and pattie 70 gathering conveyor 55 with a transfer rail 55 to deflect sliced roll 72 and patties 70 from biscuit conveyor 50 to gathering conveyor 55 and with multiple guide rails 57; (d) a pair of servo drive chains 60A,60B to turn patties 70 or other foodstuffs/items, the pair of servo drive chains 60A,60B further comprising a pair of motors and gear drives 62, a chain 63, and a set of pockets 64 on drive chain 63; (e) a slider rail 65 between servo drive 60A,60B; (f) a placement device 66 of the pattie into a sliced bun, and (g) a pack out tray, box, or gathering device 85 wherein the food grade system 30 for placing egg, meat, and protein patties 70 onto rolls/biscuits 72 and assembling a sandwich 74 and a person 90 attending and finishing sandwich assembly is able to efficiently and quickly assembly sandwiches in a relatively small workplace and floor space.

An overview of the feeding system theory of operation for the food grade feeder device and system to assemble and prepare a sandwich is generally as follows:
a) this will be used to automate the assembly of sandwiches;
b) it introduces sausage or egg patties to the feeding system in bulk;
c) the sausage or egg patties are singulated using the Hoosier System's FDA centrifugal feed system application Ser. No. 16/389,868 filed by Schombert on Apr. 19, 2019 and called a Food grade feeder device and system for rolls, sandwiches, odd shaped edibles and foodstuff;
d) the patties are placed into pockets on the “servo drive chain”;
e) two (2) servo motors with separate belts that run independently;
f) a top belt has pockets on ⅓ of the belt—bottom belt has pockets on ⅓ of the belt;
g) one can think of this system as two separately servo driven trains:
   1) while loading one train, the other train is unloading;
   2) one can and can load (at feeder bowl) much faster than one can unload (at bread conveyor);
   3) so #1 train that has just unloaded, races to re-load and catch up to the tail of the #2 train, repeat cycle.
   4) thus not missing a single unit of bread

The process for singulating and placing rolls, egg, meat or protein patties, and/or cheese and other foodstuffs to assemble and prepare a sandwich, the process using a food grade feeder and system and comprised of:

| Step | Activity |
|---|---|
| Step 1: | Step 1: bulk feeding specific food items (egg, meat |
| | or protein patties, possibly cheese and/or sliced |
| | tomatoes and other food items) through a food grade |
| | centrifugal feed system; |
| Step 2: | Step 2: placing or sliding the food items with a |
| | chain driven pick and place or slide and place |
| | device; |
| Step 3: | Step 3: transferring over food items to two |
| | separate servo driven trains; |
| Step 4: | Step 4: placing pattie into a sliced roll or |
| | placing a top roll/ biscuit to complete sandwich; |
| Step 5: | Step 5: wrapping of completed sandwich, if desired; |
| | and |
| Step 6: | Step 6: placing on serving or transfer tray, box or |
| | container. |

Many different uses are anticipated for the food feeder and system 30. Some examples, and not limitations, are shown in the following Table.

| ITEM | DESCRIPTION |
|---|---|
| 1 | ready to eat sandwich - breakfast, |
| | lunch or dinner |
| 2 | sandwich rolls and buns |
| 3 | disk-like vegetables such as |
| | lettuce, onions, tomatoes |
| 4 | include preform meat patties |
| 5 | pre-cooked meats such as ham, |
| | hamburgers, turkey, pork, etc. |
| 6 | preformed cheese disks or strips |

With this description it is to be understood that the food grade feeder device and system 30 to assemble and prepare a sandwich called a Patty Placer is not to be limited to only the disclosed embodiment of product. The features of the present invention 30 are intended to cover various modifications and equivalent arrangements included within the spirit and scope of the description.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. Various features and aspects of the disclosed embodiments can be combined with or substituted for one another to form varying modes of the disclosed inventions. Thus, it is intended that the scope of at least some of the present inventions herein disclosed should not be limited by the disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any embodiment, feature, or combination of features shown herein. This is true even if only a single embodiment of the feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

1. A food grade feeder device and singulating system (30) made of durable materials, the feeder device and singulating system comprised of:
(a) an egg, meat, or protein centrifugal feeder (40);
(b) a biscuit conveyor (50) and a roll (72) and pattie (70) and a gathering conveyor (55);
(c) a pair of servo drive chains (60A,60B) to turn patties (70) or other foodstuffs/items, the pair of servo drive chains (60A,60B) further comprising a pair of motors and gear drives (62), a chain (63), and a set of pockets (64) on drive chain (63);
(d) a slider rail (65 between servo drive (60A,60B); and
(e) a placement device (66) of the pattie into a sliced bun wherein the food grade singulating system (30) for placing meat an egg, meat and/or protein patties (70) onto rolls/biscuits (72) and assembling a sandwich (74) and a person (91) attending and finishing sandwich assembly is able to efficiently and quickly assembly sandwiches in a relatively small workplace and floor space.

2. The food grade feeder device and singulating system (30) in claim 1 further comprised with a centrifugal feeder (45) for a series of sliced rolls, biscuits, and buns.

3. The food grade feeder device and singulating system (30) in claim 1 further comprised with a pack out tray, box, or gathering device (85).

4. The food grade feeder device and singulating system (30) in claim 1 wherein the gathering conveyor (55) is further comprised with multiple guide rails (57) and a transfer rail (55) to deflect one of a series of sliced rolls, biscuits, and buns (72) and patties (70) from biscuit conveyor (50).

5. The food grade feeder device and singulating system (30) in claim 1 wherein the pair of servo drive chains (60A,60B) is further comprised with a pair of motors and gear drives (62, a chain (63), and a set of pockets (64) on drive chain (63).

6. The food grade feeder device and singulating system (30) in claim 1 wherein the durable material is selected from a group consisting of an Acrylonitrile-Butadiene-Styrene (ABS), an acetal resin plastic, a 304 Stainless Steel, and a composite material.

7. The food grade feeder device and singulating system (30) in claim 1 wherein the durable material is washable with hot water and commercial soaps for quasi sterilization.

8. A food grade feeder device and singulating system (30) made of durable materials, the feeder device and singulating system comprised of:
(a) an egg, meat, or protein centrifugal feeder (40);
(b) a centrifugal feeder (45) for feeding a series of sliced rolls, biscuits, and buns;
(c) a biscuit conveyor (50) and a roll (72) and pattie (70) gathering conveyor (55) with multiple guide rails (57) and a transfer rail (55) to deflect one of a series of sliced rolls, biscuits, and buns (72) and patties (70) from the biscuit conveyor (50);
(d) a pair of servo drive chains (60A,60B) to turn patties (70) or other foodstuffs/items, the pair of servo drive chains (60A,60B) further comprising a pair of motors and gear drives (62), a chain (63), and a set of pockets (64) on drive chain (63);
(e) a slider rail (65) between the servo drive (60A,60B);
(f) a placement device (66) of the pattie into one of the a series of sliced rolls, biscuits, and buns; and
(g) a pack out tray, box, or gathering device (85) wherein the food grade singulating system (30) for placing meat an egg, meat and/or protein patties (70) onto rolls/biscuits (72) and assembling a sandwich (74) and a person (91) attending and finishing sandwich assembly is able to efficiently and quickly assembly sandwiches in a relatively small workplace and floor space.

9. The food grade feeder device and singulating system (30) in claim 8 wherein the durable material is selected from a group consisting of an Acrylonitrile-Butadiene-Styrene (ABS), an acetal resin plastic, a 304 Stainless Steel, and a composite material.

10. The food grade feeder device and singulating system (30) in claim 8 wherein the durable material is washable with hot water and commercial soaps for quasi sterilization.

11. A process for placing a series of rolls, eggs, meats and protein patties, cheese and other foodstuffs to assemble and prepare a sandwich, the process using a food grade feeder and system and comprised of:
Step 1: bulk feeding specific food items (egg, meat or protein patties, possibly cheese and/or sliced tomatoes and other food items) through a food grade centrifugal feed system;
Step 2: placing or sliding the food items with a chain driven pick and place or slide and place device;
Step 3: transferring over food items to two separate servo driven trains;
Step 4: placing pattie into a sliced roll or placing a top roll/biscuit to complete a sandwich; and
Step 5: placing the sandwich on a tray, box or container.

12. A process for placing a series of rolls, eggs, meats and protein patties, cheese and other foodstuffs to assemble and prepare a sandwich in claim 11 further comprised with
Step 4-1/2: wrapping of a completed sandwich.
